(19) United States
(12) Patent Application Publication
(10) Pub. No.: US 2025/0208606 A1
(43) Pub. Date: Jun. 26, 2025

(54) APPARATUS AND METHOD FOR ANALYZING MANUFACTURING PROCESS DATA

(71) Applicant: SAMSUNG SDI CO., LTD., Yongin-si (KR)

(72) Inventor: Hye Lynn KIM, Suwon-si (KR)

(21) Appl. No.: 18/633,350

(22) Filed: Apr. 11, 2024

(30) Foreign Application Priority Data
Dec. 22, 2023 (KR) 10-2023-0189868

(51) Int. Cl. G05B 19/418; G05B 19/042; G06N 20/00

(52) U.S. Cl. CPC G05B 19/4183; G05B 19/042; G05B 19/41885; G06N 20/00

(57) ABSTRACT

An apparatus for analyzing manufacturing process data includes a data collection module configured to collecting data generated from facilities in a battery manufacturing process for each process factor; a storage device configured to store the collected data; and a processor operatively coupled to the data collection module and the storage device, and configured to preprocess the data for each process factor collected though the data collection module based on continuity between unit processes.

### CROSS-REFERENCE TO RELATED APPLICATION

The present application claims priority to and the benefit of Korean Patent Application No. 10-2023-0189868, filed on Dec. 22, 2023, in the Korean Intellectual Property Office, the entire disclosure of which is incorporated herein by reference.

### BACKGROUND

### 1. Field

Aspects of embodiments of the present invention relate to an apparatus and method for analyzing data generated in a battery electrode manufacturing process.

### 2. Description of the Related Art

Commonly known quality inspection items for lithium ion battery (LIB) electrodes include thickness and loading level. In particular, a cathode electrode is rolled under heat during a rolling process, resulting in various types of deformation. Thereamong, convex curvature of both surfaces of an electrode plate subjected to rolling can cause miswinding, which is a phenomenon in which the electrode plate is wound in a direction deviating from an axial direction of a winding core when wound into a coil.

Because defects occurring during an intermediate process can cause significant quality defects in final products, sampling inspection is performed after manufacture of electrode plates.

In general, LIB electrodes are manufactured in the form of a roll by coating a composite containing an electrode active material in paste form onto a current collector composed of a strip-shaped metal thin film, and the like, followed by drying to form an active material layer. Then, the current collector with the active material layer formed thereon is rolled to a predetermined thickness, slit to a set or predetermined width (into reels), and cut to a set length, thereby obtaining a complete electrode plate for a battery cell.

The electrode manufacturing process generates a lot of data related to control conditions for a facility in each unit process and collected from sensors in the facility. However, because process-induced shape changes (for example, cutting of a roll into reels) occur until the electrode is completed, it is difficult to connect data without location information. Although recording the time when data is generated facilitates data connection through conversion of time information into location information in consideration of the moving speed of electrode plates in a corresponding facility, most data generated during the manufacturing process are not recorded with time information.

In addition, although some data, such as thickness and loading level, is collected from sensors in real time during quality inspection for electrode plates, some inspection items, such as curvature, are inspected by sampling inspection only.

In curvature inspection, the amount of deformation of an electrode plate due to curvature may be measured using a piece cut from an electrode made in the form of a reel. Although this is an important quality assessment, difficulty in inspecting all products makes it difficult to determine the cause of the defect.

Therefore, it is desirable to connect a curvature value to preceding process data in order to determine a process that contributes most to the occurrence of curvature using a machine learning model. However, data generated in the electrode plate manufacturing process are recorded with location or time information and are thus difficult to connect to each other, and the number of data generated is different for each facility in a unit processes. In addition, although data connection may be achieved through data compression on a roll or reel basis, this can reduce data consistency.

The above information disclosed in this Background section is only for enhancement of understanding of the background of the invention and therefore it may contain information that does not form the prior art.

### SUMMARY

Aspects of some embodiments of the present invention are directed to an apparatus and method for analyzing manufacturing process data, which can determine the causes of errors by performing data mapping through data connection and generating a prediction model using statistical analysis or machine learning even when there is a difference in number of data items between datasets collected in a battery electrode manufacturing process.

The above and other aspects and features of the present invention will become apparent from the following description of embodiments of the present invention.

In accordance with some embodiments of the present invention, there is provided an apparatus for analyzing manufacturing process data, the apparatus including: a data collection module configured to collecting data generated from facilities in a battery manufacturing process for each process factor; a storage device configured to store the collected data; and a processor operatively coupled to the data collection module and the storage device, and configured to preprocess the data for each process factor collected though the data collection module based on continuity between unit processes.

In some embodiments, the processor is configured to preprocess the data for each process factor by arranging datasets for each process factor collected though the data collection module in chronological order, to group each dataset based on a number of data items, to map the number of data items for each group through data connection for each process factor, and to perform data connection based on the continuity between the unit processes.

In some embodiments, the processor is configured to determine the number of data items in each of the datasets arranged in chronological order and to group each of the datasets based on the number of data items in a dataset including fewest data items.

In some embodiments, after grouping each of the datasets, the processor is configured to map the number of data items by repeating a dataset including fewer data items among the datasets for each group.

In some embodiments, the processor is configured to assign IDs for each process factor and to assign a linkage ID in response to data connection for each process factor by sequentially connecting the IDs to each other.

In some embodiments, the processor is configured to generate a prediction model through machine learning based on the preprocessed data for each process factor to analyze causes of errors.

In some embodiments, the processor is configured to generate the prediction model using a machine learning model including at least one of a ridge regression model, a least absolute shrinkage and selection operator (LASSO) model, a chi-square automatic interaction detector (CHAID) model, a classification and regression tree (CART) model, or a random forest model.

In accordance with some embodiments of the present invention, there is provided a method for analyzing manufacturing process data, the method including: arranging, by a processor, datasets for each process factor collected through a data collection module in chronological order; grouping, by the processor, each of the datasets arranged in chronological order based on a number of data items; mapping, by the processor, the number of data items for each group through data connection for each process factor; and performing, by the processor, data connection based on continuity between unit processes.

In some embodiments, in the grouping each of the datasets, the processor is configured to determine the number of data items in each of the datasets arranged in chronological order and to group each of the datasets based on the number of data items in a dataset including fewest data items.

In some embodiments, in the mapping the number of data items, the processor is configured to map the number of data items by repeating a dataset including fewer data items among the datasets for each group.

In some embodiments, the method further includes: assigning, by the processor, IDs for each process factor and assigning a linkage ID upon data connection for each process factor by sequentially connecting the IDs to each other. In some embodiments, the method further includes: analyzing, by the processor, causes of errors by generating a prediction model through machine learning based on the preprocessed data for each process factor.

In some embodiments, in the analyzing causes of errors, the processor is configured to generate the prediction model using a machine learning model including at least one of a ridge regression model, a LASSO model, a CHAID model, a CART model, or a random forest model.

The apparatus and method for analyzing manufacturing process data according to some embodiments of the present invention can determine the cause of errors by performing data mapping through data connection and generating a prediction model using statistical analysis or machine learning even when there is a difference in number of data items between datasets collected in a battery electrode manufacturing process.

However, aspects and features of the present invention are not limited to those described above and other aspects and features not mentioned will be clearly understood by those skilled in the art from the detailed description given below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a block diagram of an apparatus for analyzing manufacturing process data according to some embodiments of the present invention;

FIG. 2 illustrates data grouping and mapping performed by the apparatus for analyzing manufacturing process data according to some embodiments of the present invention;

FIG. 3 illustrates data connection between unit processes performed by the apparatus for analyzing manufacturing process data according to some embodiments of the present invention;

FIG. 4 is a flow diagram of a method for analyzing manufacturing process data according to some embodiments of the present invention;

FIG. 5 is a graph comparing actual values and predicted values obtained by the method for analyzing manufacturing process data, according to some embodiments of the present invention; and

FIG. 6 illustrates major factors obtained by the method for analyzing manufacturing process data in order of importance, according to some embodiments of the present invention.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or provided in plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

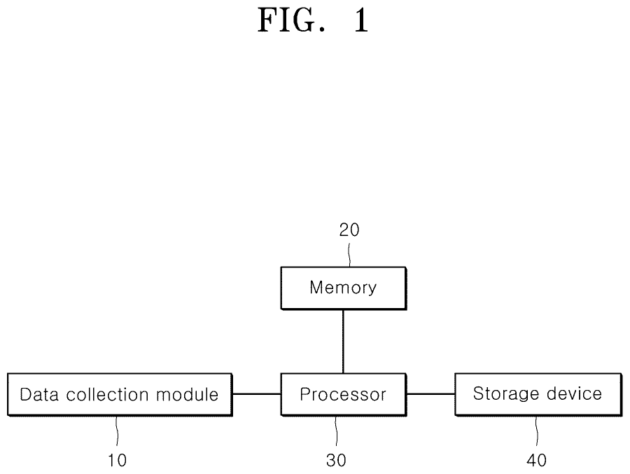

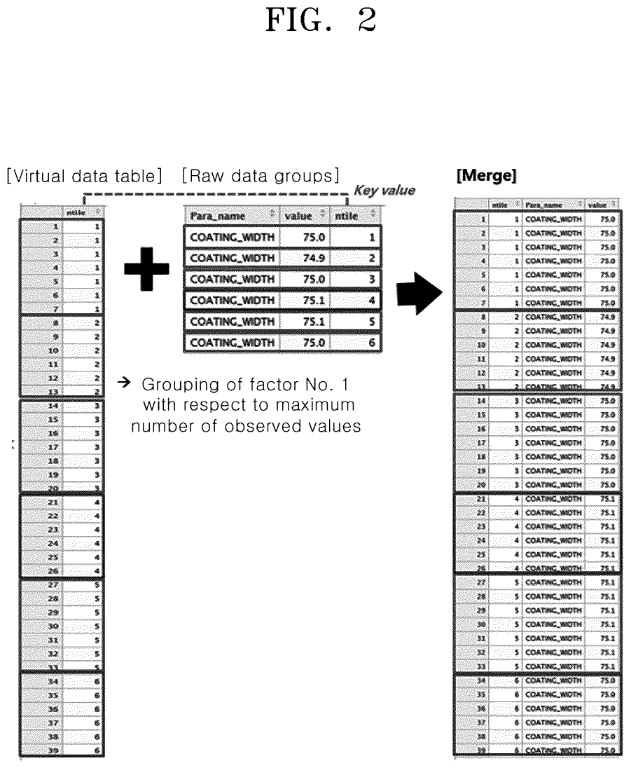

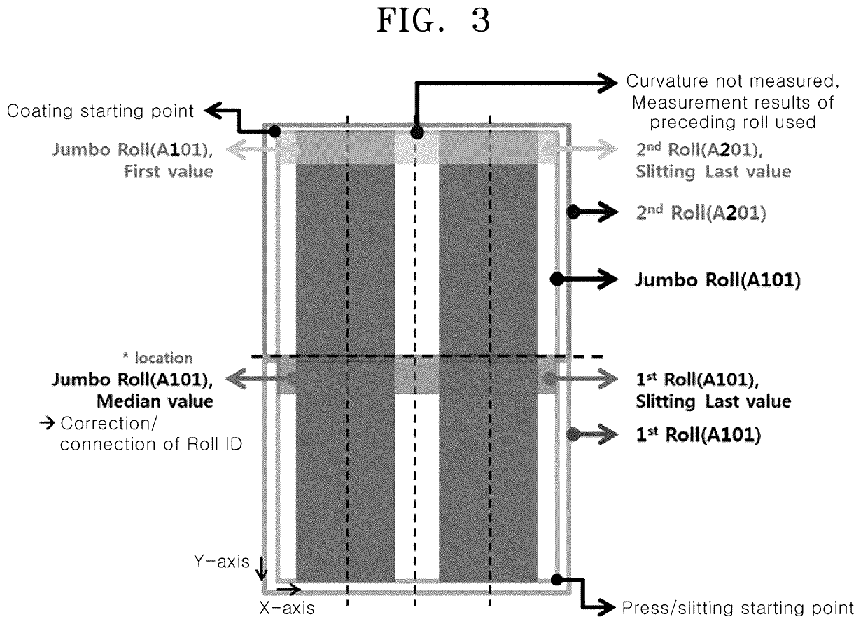

FIG. 1 is a block diagram of an apparatus for analyzing manufacturing process data according to some embodiments of the present invention. FIG. 2 illustrates data grouping and mapping performed by the apparatus for analyzing manufacturing process data according to some embodiments of the present invention. FIG. 3 illustrates data connection between unit processes performed by the apparatus for analyzing manufacturing process data according to some embodiments of the present invention.

Referring to FIG. 1, an apparatus for analyzing manufacturing process data according to some embodiments of the present invention may include a data collection module 10, a storage device 40, a memory 20, and a processor 30.

The data collection module 10 may collect time-series data generated from facilities in a battery manufacturing process for each process factor.

The manufacturing process may involve passing a battery through many facilities while also passing the battery through several process stages. The data collection module 10 may collect data on control conditions for each facility and data from sensors as time-series data for each process factor. Here, the number of data items in the time-series data collected by the data collection module 10 may vary depending on data generation intervals and sampling intervals.

The storage device 40 may store the data collected by the data collection module 10.

The memory 20 may store an executable program related to operation of the apparatus for analyzing manufacturing process data. The information stored in the memory 20 may be selected by the processor 30 as desired.

That is, the memory 20 stores instructions and various suitable types of data generated during execution of an operating system (O/S) or application (e.g., program or applet) for operating the apparatus for analyzing manufacturing process data. The memory 20 may include a non-volatile memory, a volatile memory, a flash memory, a hard disk drive (HDD), a solid state drive (SSD), and/or the like. In addition, the memory 20 may be accessed by the processor 30 for reading/writing/modification/deletion/update of data stored therein.

The processor 30 may be operatively coupled to the data collection module 10, the storage device 40, and the memory 20 and may be configured to: execute at least one instruction stored in the memory 20 to control the overall operation of the apparatus for analyzing manufacturing process data; and store data resulting from execution of the instruction in the memory 20.

The processor 30 is an entity that manages the apparatus for analyzing manufacturing process data. The processor 30 may be implemented as a central processing unit (CPU), a system on chip (SoC), and/or the like, may execute an operating system or an application to control a plurality of hardware or software components connected to the processor 30, and may perform various suitable data processing and computation tasks.

That is, upon execution of the executable program stored in the memory 20, the processor 30 may collect data for each process factor through the data collection module 10, store the collected data in the storage device 40, arrange the collected data in a set order (e.g., in chronological order), and perform data grouping based on the number of data items.

For example, referring to FIG. 2, the processor 30 may arrange datasets for each process factor in a set order (e.g., in chronological order), determine the number of data items in each dataset, and group each dataset based on the number of data items in a dataset including the fewest data items.

For example, assuming that dataset A includes 39 data items and dataset B includes 6 data items, dataset A may be grouped into 6 groups. Here, each group name is used as a key value and the number of data items in dataset B increases equal to that of the data A by connecting dataset B to dataset A.

Accordingly, after grouping each of the datasets for each process factor, the processor 30 may connect the datasets to each other to map the number of data items through repetition of a dataset including fewer data items among the datasets for each group so as to increase the number of data items.

Then, the processor 30 may preprocess the data for each process factor through data connection based on continuity between unit processes.

Referring to FIG. 3, data connection may be performed in consideration of process characteristics, such as points where a roll is wound/unwound and cut into reels during an electrode manufacturing process.

For example, a roll is wound again after completion of electrode coating and drying processes, unwound again for a subsequent rolling process, and then wound again, which changes the order of data collection and the point at which a dataset is to be connected to (e.g., tied to or associated with) another dataset. Accordingly, data connection may be performed in consideration of location information. This allows connection between all data generated during the electrode manufacturing process.

The processor 30 may assign IDs for each process factor and may assign a linkage ID upon data connection for each process factor by sequentially connecting the IDs to each other.

For example, in order to connect (e.g., link or associate) data between unit processes, first, IDs generated for unit processes may be connected to (e.g., linked to or associated with) one another. A product resulting from a coating process, which is the first unit process in the electrode manufacturing process, is referred to as a “jumbo roll” and may be assigned a jumbo roll ID. In a press process, which is the second unit process, the jumbo roll is cut lengthwise n times (n being an integer greater than zero). N products (N being an integer greater than n) resulting from the press process are referred to as “rolls” and may be assigned n roll IDs. In a slitting process, which is the last unit process, an electrode is cut widthwise into m pieces (m being an integer greater than zero). Each product resulting from the slitting process is referred to as a “‘reel” and may be assigned a reel ID by adding a letter or number, such as a/b/c/d or 1/2/3/4, to the end of the roll ID.

Accordingly, the jumbo roll ID, the roll ID, and the reel ID may be configured with logic that enables each thereof to be connected to (e.g., linked to or associated with) a preceding process ID. That is, assuming the jumbo roll ID is A, the roll ID may be, for example, A101, A201, or the like, and the reel ID may be, for example, A101a, A101b, A201a, A201b, or the like.

After preprocessing the collected process factor data, the processor 30 may generate a prediction model through machine learning based on the preprocessed process factor data to analyze the causes of errors.

Here, the processor 30 may generate the prediction model using a machine learning model including a ridge regression model, a least absolute shrinkage and selection operator (LASSO) model, a chi-square automatic interaction detector (CHAID) model, a classification and regression tree (CART) model, a random forest model, and/or the like.

That is, when sampling indicates that there is an error in a target Y value (e.g., curvature, adhesion, etc.), the processor 30 may analyze the cause of the error by connecting the target Y value to the last part of process factor data and generating a prediction model through machine learning based on the connected process factor data.

When desired accuracy is obtained through analysis of the cause of the error using the generated prediction model, the processor 30 may obtain a predictive value based on a related process factor and may find major factors that affect a related process, for example, factors that cause errors.

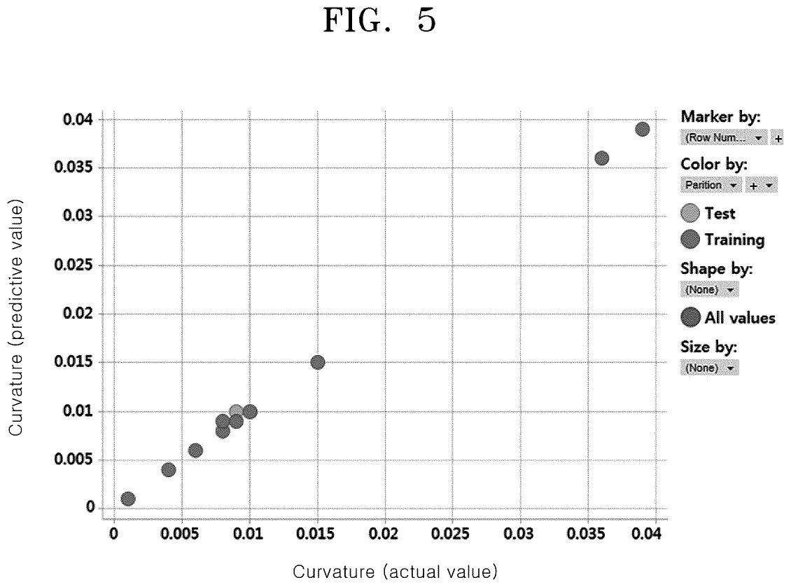

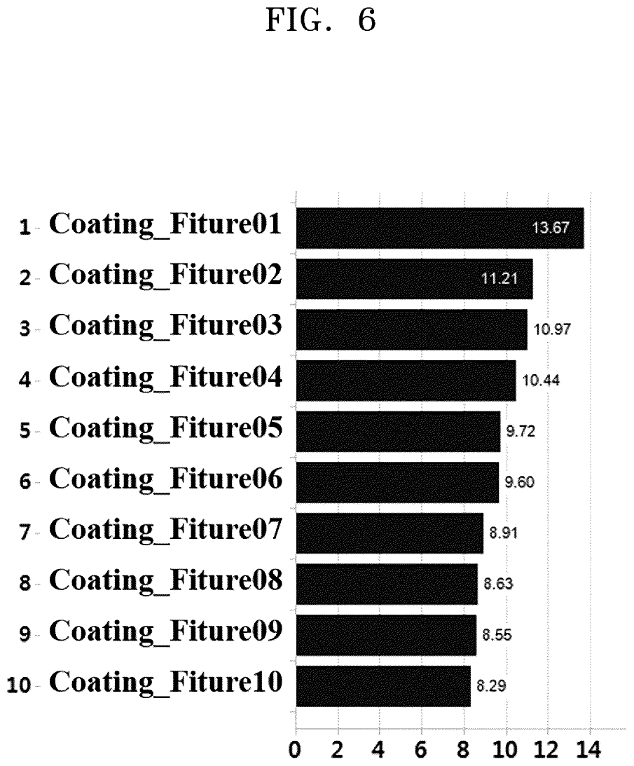

For example, accuracy may be determined by plotting predicted curvature values obtained through the prediction mode and actual curvature values on a graph, as shown in FIG. 5. In some examples, the importance of process factors (for example, coating features) that affect a related process may be obtained and represented in the form of a bar chart, as shown in FIG. 6.

When desired accuracy fails to be obtained, the processor 30 may change the prediction model to analyze the cause of the error.

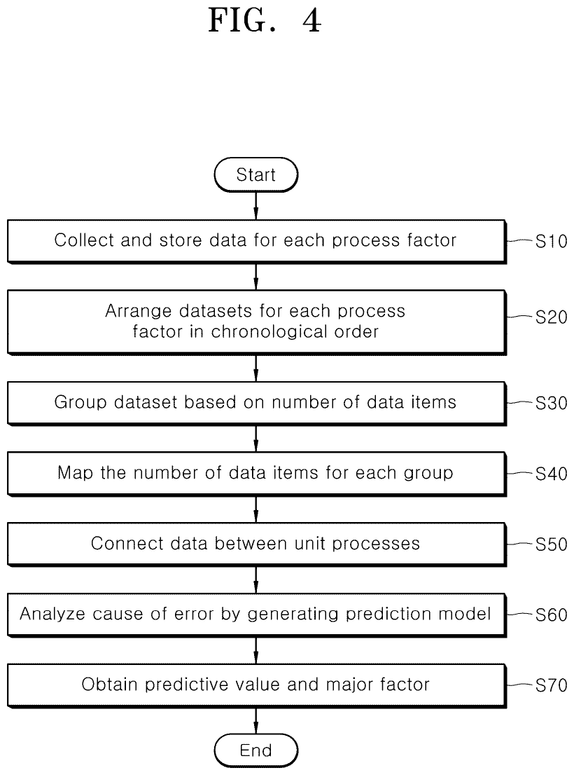

FIG. 4 is a flow diagram of a method for analyzing manufacturing process data according to some embodiments of the present invention. FIG. 5 is a graph comparing actual values and predicted values obtained by the method for analyzing manufacturing process data, according to some embodiments of the present invention. FIG. 6 illustrates major factors obtained by the method for analyzing manufacturing process data in order of importance, according to some embodiments of the present invention.

Referring to FIG. 4, in the method for analyzing manufacturing process data according to some embodiments of the present invention, first, a processor 30 executes an executable program stored in a memory 20, collects data for each process factor through a data collection module 10, and stores the collected data in a storage device 40 (S10).

The data collection module 10 may collect time-series data for each process factor generated in facilities in a battery manufacturing process for each process factor.

The battery manufacturing process involves the battery passing through many facilities while also passing through several process stages. Here, the data collection module 10 may collect data on control conditions for each facility and data from sensors as time series data for each process factor. Here, the number of data items of the time-series data collected by the data collection module 10 may vary depending on data generation intervals and sampling intervals.

The processor 30 may assign IDs for each process factor upon collecting data for each process factor and may assign a linkage ID upon data connection for each process factor by sequentially connecting the IDs to each other.

For example, in order to connect (e.g., link or associated) data between unit processes, first, IDs generated for unit processes may be connected to (e.g., linked to or associated with) one another. A product resulting from a coating process, which is the first unit process in the electrode manufacturing process, is referred to as a “jumbo roll” and may be assigned a jumbo roll ID. In a press process, which is the second unit process, the jumbo roll is cut lengthwise n times (n being an integer greater than zero). N products (N being an integer greater than n) resulting from the press process are referred to as “rolls” and may be assigned n roll IDs. In a slitting process, which is the last unit process, an electrode is cut widthwise into m pieces (m being an integer greater than zero). Each product resulting from the slitting process is referred to a “‘reel” and may be assigned a reel ID by adding a letter or number, such as a/b/c/d or 1/2/3/4, to the end of the roll ID.

Accordingly, the jumbo roll ID, the roll ID, and the reel ID may be configured with logic that enables each thereof to be connected to (e.g., linked to or associated with) a preceding process ID. That is, assuming the jumbo roll ID is A, the roll ID may be, for example, A101, A201, or the like, and the reel ID may be, for example, A101a, A101b, A201a, A201b, or the like.

After collecting data for each process factor in the manufacturing process of S10, the processor 30 arranges collected datasets for each process factor in a set order (e.g., in chronological order) (S20).

After arranging the datasets in a set order (e.g., in chronological order) in the operation of S20, the processor 30 groups each of the datasets arranged in a set order (e.g., in chronological order) based on the number of data items (S30).

After grouping each of the datasets based on the number of data items in operation S30, the processor 30 maps the number of data items for each group by performing data connection for each process factor (S40).

That is, as shown in FIG. 2, the processor 30 may arrange the datasets for each process factor in a set order (e.g., in chronological order), determine the number of data items in each dataset, and group each dataset based on the number of data items of a dataset including the fewest data items.

For example, assuming that dataset A includes 39 data items and dataset B includes 6 data items, dataset A may be grouped into 6 groups. Here, each group name is used as a key value and the number of data items in dataset B increases equal to that of dataset A by connecting dataset B to dataset A.

Accordingly, after grouping each of the datasets, the processor 30 may connect the datasets to each other to map the number of data items through repetition of a dataset including fewer data items among the datasets for each group so as to increase the number of data items.

After mapping the number of data items in each of the datasets for each process factor in operation S40, the processor 30 performs data connection based on continuity between unit processes (S50).

As shown in FIG. 3, data connection may be performed in consideration of process characteristics, such as points where a roll is wound/unwound and cut into reels during an electrode manufacturing process.

For example, a roll is wound again after completion of electrode coating and drying processes, unwound again for a subsequent rolling process, and then wound again, which changes the order of data collection and the point at which a dataset is to be connected to (e.g., linked to or associated with) another dataset. Accordingly, data connection may be performed in consideration of location information. This allows connection between all data generated during the electrode manufacturing process.

After preprocessing the collected data through data connection based on continuity between unit processes in operation S50, the processor 30 may analyze the causes of errors by generating a prediction model through machine learning based on the preprocessed process factor data (S60).

Here, the processor 30 may generate the prediction model using a machine learning model including a ridge regression model, a LASSO model, a CHAID model, a CART model, a random forest model, and/or the like.

That is, when sampling indicates that there is an error in a target Y value (e.g., curvature, adhesion, etc.), the processor 30 may analyze the cause of the error by connecting the target Y value to the last part of process factor data and generating a prediction model through machine learning based on the connected process factor data.

When desired accuracy is obtained through analysis of the cause of the error using the generated prediction model in operation S60, the processor 30 may obtain a predictive value based on a corresponding process factor and may find major factors that affect a corresponding process, for example, factors that cause errors.

For example, accuracy may be determined by plotting predicted curvature values obtained through the prediction mode and actual curvature values on a graph, as shown in FIG. 5. In some examples, the importance of process factors (for example, coating features) that affect a related process may be obtained and represented in the form of a bar chart, as shown in FIG. 6.

When desired accuracy fails to be obtained, the processor 30 may change the prediction model to analyze the cause of the error.

As described above, the apparatus and method for analyzing manufacturing process data according to some embodiments of the present invention can determine the cause of errors by performing data mapping through data connection and generating a prediction model using statistical analysis or machine learning even when there is a difference in number of data items between datasets collected in a battery electrode manufacturing process.

As used herein, the term “module” may include a unit implemented in hardware, software, or firmware, and may be used interchangeably with terms, such as, for example, logic, logic block, component, or circuit. A “module” may be an integrally formed part or a minimal unit or portion of the part that performs one or more functions. For example, according to some embodiments, the “module” may be implemented in the form of an application-specific integrated circuit (ASIC).

In addition, the embodiments described herein may be implemented, for example, as a method or process, a device, a software program, a data stream, or a signal. Although discussed in the context of a single type of implementation (for example, discussed only as a method), features discussed herein may also be implemented in other forms (for example, a device or a program). The device may be implemented by suitable hardware, software, firmware, and the like. The method may be implemented on a device, such as a processor that generally refers to a processing device including a computer, a microprocessor, an integrated circuit, a programmable logic device, etc. The processor includes a communication device such as a computer, a cell phone, a personal digital assistant (PDA), and other devices that facilitate communication of information between the device and end-users.

Although the present invention has been described with reference to some embodiments and drawings illustrating aspects thereof, it should be understood that these embodiments are provided for illustration only and are not to be construed in any way as limiting the present invention, and that various suitable modifications, changes, alterations, and equivalent embodiments can be made by those skilled in the art without departing from the spirit and scope of the invention.

Therefore, the scope of the present invention should be defined by the appended claims and equivalents thereof.

What is claimed is:

1. An apparatus for analyzing manufacturing process data, comprising:
a data collection module configured to collecting data generated from facilities in a battery manufacturing process for each process factor;
a storage device configured to store the collected data; and
a processor operatively coupled to the data collection module and the storage device, and configured to preprocess the data for each process factor collected though the data collection module based on continuity between unit processes.

2. The apparatus as claimed in claim 1, wherein the processor is configured to preprocess the data for each process factor by arranging datasets for each process factor collected though the data collection module in chronological order, to group each dataset based on a number of data items, to map the number of data items for each group through data connection for each process factor, and to perform data connection based on the continuity between the unit processes.

3. The apparatus as claimed in claim 2, wherein the processor is configured to determine the number of data items in each of the datasets arranged in chronological order and to group each of the datasets based on the number of data items in a dataset comprising fewest data items.

4. The apparatus as claimed in claim 2, wherein, after grouping each of the datasets, the processor is configured to map the number of data items by repeating a dataset comprising fewer data items among the datasets for each group.

5. The apparatus as claimed in claim 2, wherein the processor is configured to assign IDs for each process factor and to assign a linkage ID in response to data connection for each process factor by sequentially connecting the IDs to each other.

6. The apparatus as claimed in claim 2, wherein the processor is configured to generate a prediction model through machine learning based on the preprocessed data for each process factor to analyze causes of errors.

7. The apparatus as claimed in claim 6, wherein the processor is configured to generate the prediction model using a machine learning model comprising at least one of a ridge regression model, a least absolute shrinkage and selection operator (LASSO) model, a chi-square automatic interaction detector (CHAID) model, a classification and regression tree (CART) model, or a random forest model.

8. A method for analyzing manufacturing process data, comprising:
arranging, by a processor, datasets for each process factor collected through a data collection module in chronological order;
grouping, by the processor, each of the datasets arranged in chronological order based on a number of data items;
mapping, by the processor, the number of data items for each group through data connection for each process factor; and
performing, by the processor, data connection based on continuity between unit processes.

9. The method as claimed in claim 8, wherein, in the grouping each of the datasets, the processor is configured to determine the number of data items in each of the datasets arranged in chronological order and to group each of the datasets based on the number of data items in a dataset comprising fewest data items.

10. The method as claimed in claim 8, wherein, in the mapping the number of data items, the processor is configured to map the number of data items by repeating a dataset comprising fewer data items among the datasets for each group.

11. The method as claimed in claim 8, further comprising:
assigning, by the processor, IDs for each process factor and assigning a linkage ID upon data connection for each process factor by sequentially connecting the IDs to each other.

12. The method as claimed in claim 8, further comprising:
analyzing, by the processor, causes of errors by generating a prediction model through machine learning based on the preprocessed data for each process factor.

13. The method as claimed in claim 12, wherein, in the analyzing causes of errors, the processor is configured to generate the prediction model using a machine learning model comprising at least one of a ridge regression model, a LASSO model, a CHAID model, a CART model, or a random forest model.
